(19) United States
(12) Patent Application Publication
(10) Pub. No.: US 2007/0263837 A1
(43) Pub. Date: Nov. 15, 2007

(54) Methods and systems for setting up a call center

(75) Inventor: Aloisio Mello, Marietta, GA (US)

Correspondence Address: POTOMAC PATENT GROUP PLLC, P.O. BOX 270, FREDERICKSBURG, VA, 22404, US

(73) Assignee: BellSouth Intellectual Property Corporation, Wilmington, DE (US)

(21) Appl. No.: 11/408,848

(22) Filed: Apr. 21, 2006

(51) Int. Cl. H04M 3/00; H04M 5/00

(52) U.S. Cl. 379/265.01

(57) ABSTRACT

Methods according to the exemplary embodiments are used to set up call centers. For example, such methods can include the steps of determining call types to be handled by the call center and a number of call agents to be supported, identifying a list of software applications to be provided to the call center based, at least in part, on the determined call types and number of call agents, ordering hardware associated with an automatic call distributor and a plurality of agent terminals to be installed within the call center based, at least in part, on the determined call types and number of call agents, and installing the hardware and the software applications to set-up the call center.

### BACKGROUND

In today's world of improved communication abilities coupled with the ever growing amount of products and services offered, companies have a need to be able to efficiently interface with the people having questions about the variety of products and services they offer. This need led to the development of call centers. A call center is a central place where customer and other telephone calls are handled by an organization, usually with some amount of computer automation. Typically, a call center has the ability to handle a considerable volume of calls at the same time, to screen calls, forward them to someone qualified to handle them (agents), and to log calls. Call centers are used by mail-order catalog organizations, telemarketing companies, computer product help desks and any large organization that uses the telephone to sell or support products and services.

As the volume of products potentially needing customer support grows, e.g., more homes getting cable, DSL, computer products, etc., the need for call centers is expected to rise. Given this trend, it would be useful to develop an efficient way to create a call center in as short a time as possible, at the lowest cost possible, while also meeting the objectives of a specific call center.

There is thus a need for efficient methods, systems and tools for setting up a call center.

### SUMMARY

Systems and methods according to the exemplary embodiments address this need and others by providing methods and systems for setting up a call center.

According to one exemplary embodiment, a method for setting up a call center includes the steps of: determining call types to be handled by the call center and a number of call agents to be supported at the call center; identifying a list of software applications to be provided to the call center based, at least in part, on the determined call types and number of call agents; ordering hardware associated with an automatic call distributor and a plurality of agent terminals to be installed within the call center based, at least in part, on the determined call types and number of call agents.

### BRIEF DESCRIPTION OF THE DRAWINGS

The accompanying drawings illustrate exemplary embodiments, wherein:

FIG. 1 is a diagram of a call center system;

FIG. 2 illustrates a timeline for establishing a call center according to exemplary embodiments;

FIG. 3 is a flowchart illustrating the events within the start-up phase according to exemplary embodiments;

FIG. 4 lists exemplary hardware according to exemplary embodiments;

FIG. 5 is a table showing relevant documents according to exemplary embodiments;

FIG. 6 is a flowchart illustrating the events within the technical design phase according to exemplary embodiments;

FIG. 7 is flowchart illustrating the events within the implementation-technical phase according to exemplary embodiments;

FIG. 8 is a flowchart illustrating the events within the implementation-operations phase according to exemplary embodiments;

FIG. 9 is a flowchart illustrating the events within the phase of project management according to exemplary embodiments;

FIG. 10 depicts an agenda for a start-up meeting with a partner according to exemplary embodiments;

FIG. 11 lists key implementation roles according to exemplary embodiments; and

FIG. 12 is an example of a job description according to exemplary embodiments.

### DETAILED DESCRIPTION

The following detailed description refers to the accompanying drawings. The same reference numbers in different drawings identify the same or similar elements. Also, the following detailed description does not limit the invention. Instead, the scope of exemplary embodiments of the invention is defined by the appended claims.

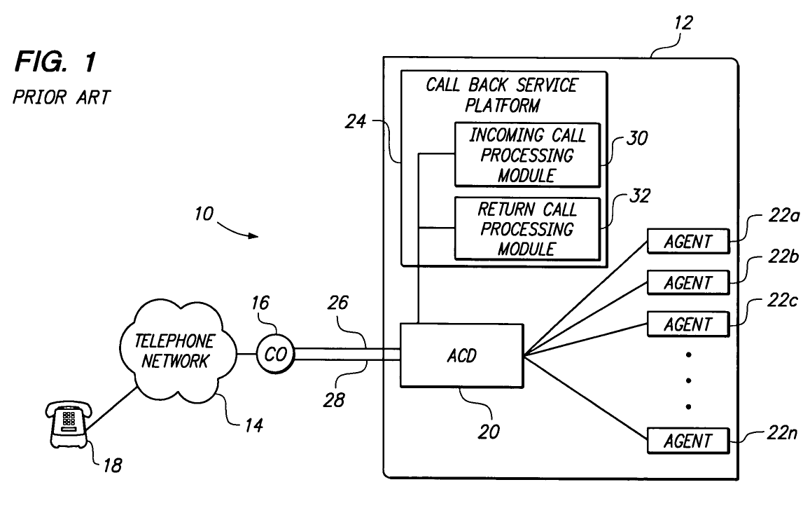

In order to provide some context for this description, an exemplary call center which can be set up using the below described systems, tools and methods will now be described with respect to FIG. 1. Therein, the system 10 includes a call center 12 in communication with a telephone network 14, such as the public switched telephone network (PSTN) and/or a wireless network, via a central office (CO) switch 16. The call center 12 may be used, for example, to provide services to a user of the telecommunications unit 18, e.g., a customer of the call center 12. In FIG. 1, the telecommunications unit 18 is illustrated as a landline telephone, however, the call center 12 may be used to provide services to users of other telecommunications units in communication with the call center 12 via the telephone network 14 such as, for example, a wireless telephone, a personal digital assistant (PDA), or a computer.

As illustrated in FIG. 1, the call center 12 may include an automatic call distributor (ACD) 20, a number of agent terminals 22a-n, and a call back service platform (CBSP) 24. The ACD 20 may be in communication with the CO switch 16 via a first communications link 26 and a second communications link 28. The communications links 26, 28 may be, for example, trunk groups such as, for example T-1 trunk circuits.

The ACD 20 may include a multiport switch (not shown) and a central processing unit (CPU) (not shown). Each of the agent terminals 22a-n is in communication with the multiport switch and, under control of the CPU, the multiport switch may route incoming calls, such as from the telecommunications unit 18, to an available agent at one of the agent terminals 22a-n. If the call center 12 is overloaded with incoming calls such that no suitable agents are available to handle calls at the moment they come in, the calls may be placed in different queues based upon pre-established criteria. In the queues, the calls await suitable agents becoming free and available to service the call. The waiting calls may be distributed to agents for handling on an oldest-call-waiting (OCW) basis. According to such a framework, the call center 12 may be used to provide call centers services to a caller, such as from the telecommunications unit 18.

The CBSP 24 may be utilized to provide call back services for a calling party to the call center 12. Additionally, the CBSP 24 may include an incoming call processing module 30 and a return call processing module 32. The modules 30, 32 may be implemented as software code to be executed by the CBSP 24 using any type of computer instruction type suitable such as, for example, microcode, and may be stored in, for example, an electrically erasable programmable read only memory (EEPROM), or can be configured into the logic of the CBSP 24. Those readers interested in more details regarding the CBSP 24 are directed to U.S. Pat. No. 6,879,683, the disclosure of which is incorporated here by reference.

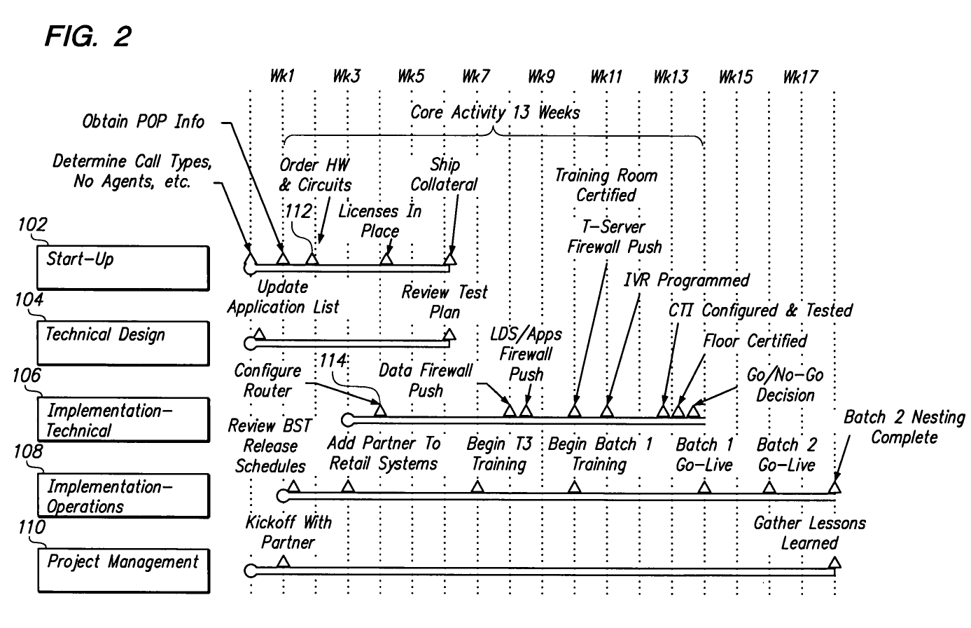

Having illustrated an exemplary call center, in order to repeatedly and efficiently set-up such centers, a planning tool is used to form the basic call center structure according to exemplary embodiments. FIG. 2 shows an exemplary timeline that can be used to form the basic structure of the plan to set-up a call center. This exemplary timeline is broken down into five major phases, each of which can have multiple events occurring therein. However, it will be appreciated that other embodiments may organize events using different groupings. The five major phases associated with this exemplary embodiment are start-up 102, technical design 104, implementation-technical 106, implementation-operations 108 and project management 110. This exemplary timeline is structured such that the planned length of time for each phase is shown, as well as the specific timing related to each event. Of course, the specific amount of time associated with each phase (and overall call center set-up time) may vary depending upon implementation-specific factors. Also it is important to note that the timing for the phases overlap and that events within each phase could affect events both within their phase and within different phases. For example, if the order hardware (hw) & circuits event 112 was sufficiently delayed, the configure router event 114 could also be delayed. An overview of each phase will now be described below.

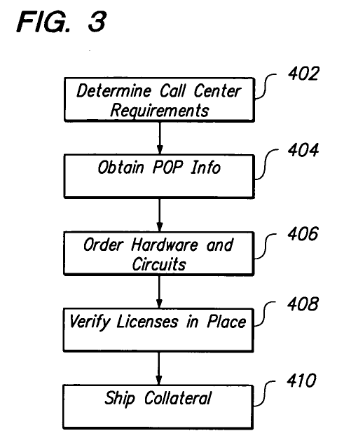

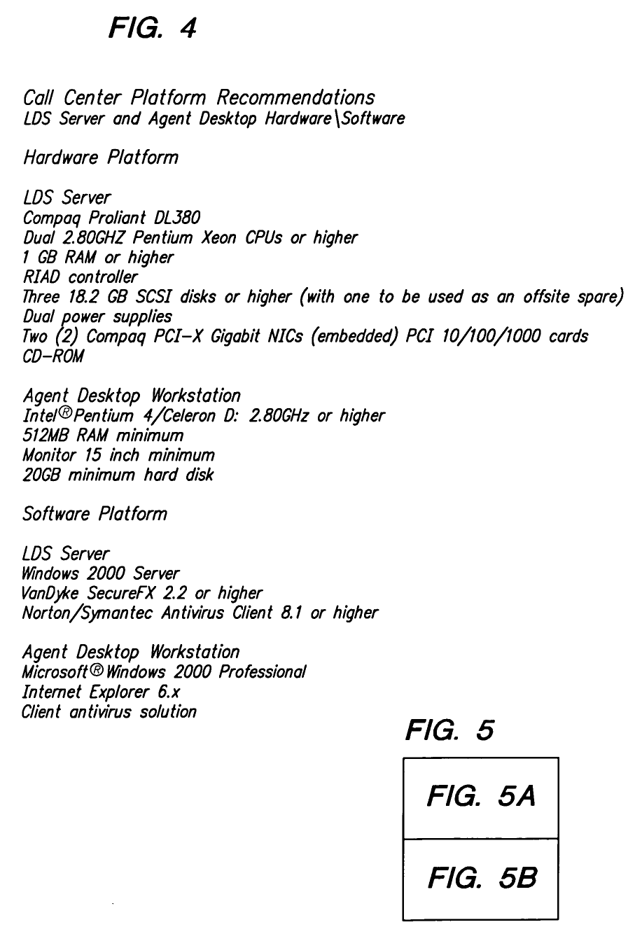

As seen in FIG. 2, phases 102, 104 and 110 are initiated at roughly the same time at the beginning of the call center set-up process. For descriptive purposes, the first phase to be described herein is start-up phase 102 which, ideally, runs just over six weeks. The flowchart of FIG. 3 shows exemplary events that occur during phase 102. The first event 402 is to determine call center, followed by the obtain point-of-presence (POP) information event 404, the order hardware (HW) and circuits event 406, the verify licenses in place event 408 and the ship collateral event 410. During the determine call center requirements event 402, the basic framework of the call center being set-up is determined. This includes, for example, identifying the call types to be received, estimating call volumes and determining the call center hours of operation, which then leads to determining the number and location of the call agents, e.g., how many terminals 22 will be needed for this particular call center. Additionally, the types of calls can influence agent training needs and skills required. For the obtain POP information event 404, information for both voice point-of-presence (POP) to be used and data POP to be used are obtained from the customer. For the order HW and circuits event 406 data circuits, voice circuits, desktops, servers, call monitoring and recording systems, and any other items needed for the wide area network are ordered as needed. A purely illustrative example of some hardware used to set-up a call center is shown in FIG. 4. The relative timing of this event is significant because of the standard lag times that exist between ordering and receiving equipment. For example, standard lag times between ordering and receiving data and voice circuits, hardware and the local distribution server (LDS) server is about six to eight weeks but could change over time. The LDS server (not shown) can be located at the call center data center and is used to cache information locally in order to speed up access to large databases.

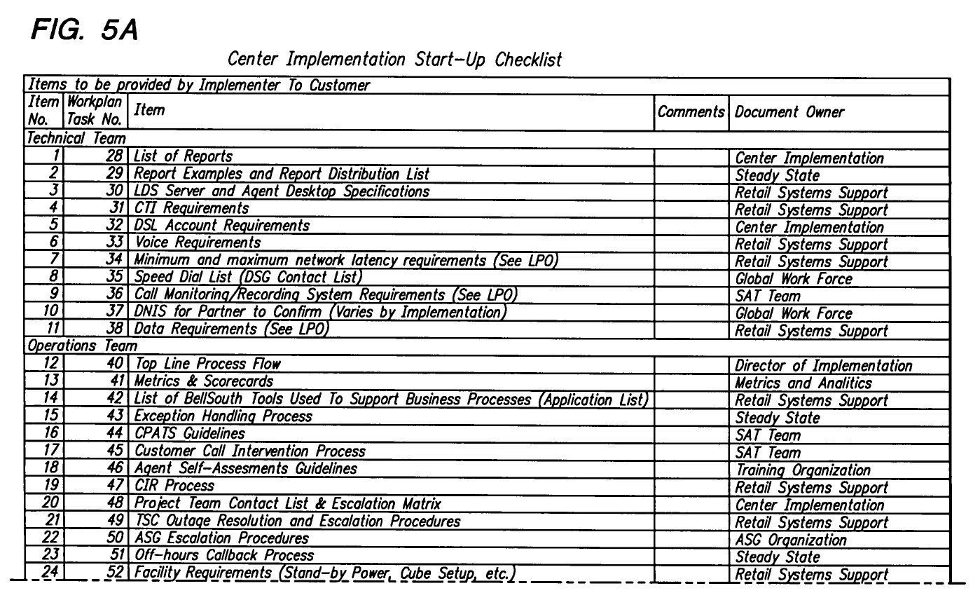

For the verify licenses in place event 408, a current inventory of licenses is performed, then it is determined which licenses are to be transferred to the customer, followed by forwarding appropriate licenses to the customer and obtaining consent for all licenses being used by customer. The final event in this phase 102 is the ship collateral event 410. During this event, company posters, memorabilia and other giveaways are ordered and shipped as needed to arrive at the call center for the launch. Additional events may also occur during the start-up phase 102 as needed that have not been described above, such as providing a list of all relevant technical and operational documentation (an example of which is shown in FIG. 5) to the customer, setting up the customer in a payment database, any desired legal reviews and any other miscellaneous items that are related to start-up.

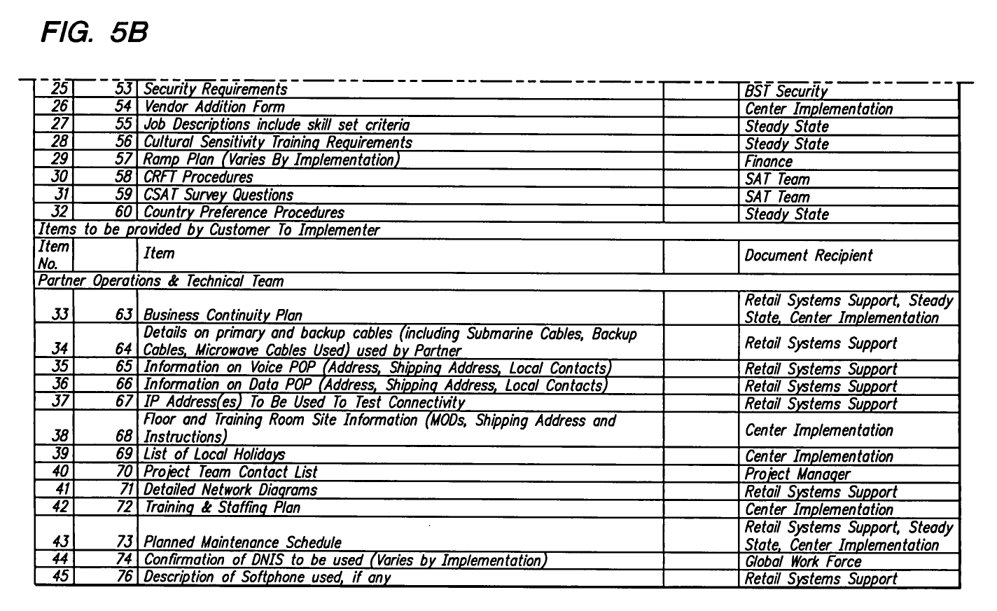

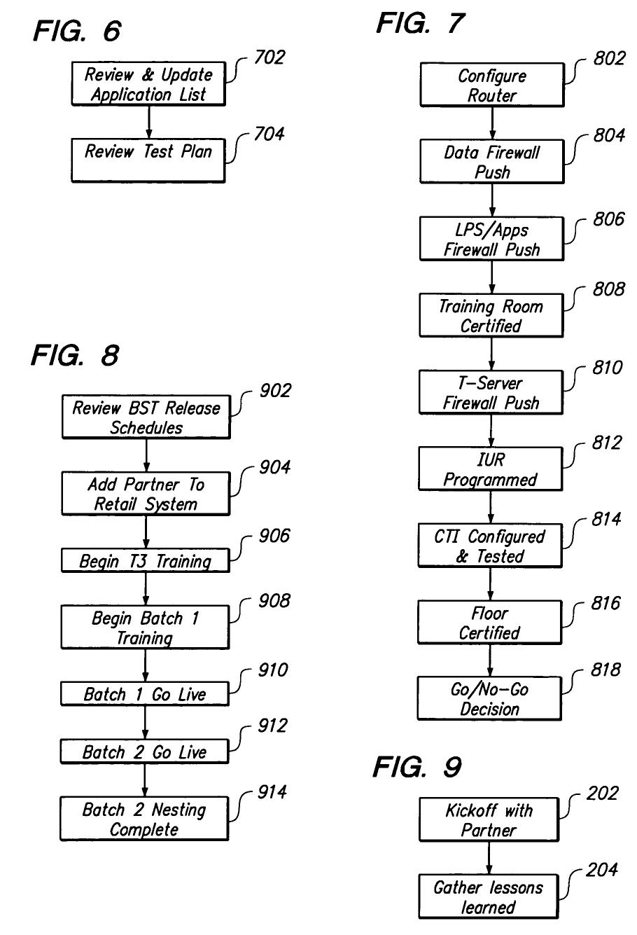

Another phase of call center set-up according to this exemplary embodiment is the technical design phase 104 which ideally runs just over six weeks as shown in FIG. 2. The flow chart of FIG. 6 shows exemplary events that occur within technical design phase 104, although other events may also be included. The first event is update application list event 702 and the second event is review test plan 704. During the update application list event 702, appropriate software applications to be used are determined, this application list is then reviewed, approved and provided to all relevant suppliers. For the review test plan event 704, the firewall push test plan(s) are reviewed with emphasis placed on connectivity issues, functionality issues and performance issues. During this phase other events that may occur are creating a data strategy, creating a voice strategy based on each call type and preparing server deployment documentation.

The next phase of call center set-up according to this exemplary embodiment is the implementation-technical phase 106 which ideally runs from week three through week fourteen as shown in FIG. 2, although other time schedules are possible. The flow chart of FIG. 7 shows exemplary events that occur within the implementation-technical phase 106. The first event is the configure router event 802, followed by data firewall push event 804, LDS/Apps firewall push event 806, training room certified event 808, T-server firewall push event 810, interactive voice response (IVR) programmed event 812, CTI configured and tested event 814, floor certified event 816 and Go/No-Go decision event 818. During the configure router event 802, routing tables are configured in order to allow access to the new links connected point-to-point between the buyer's network and the seller's network. For the data firewall push event 804, and LDS/Apps firewall push event 806, access is allowed only to applications and ports to support the service and secure the network. Upon verification of completion of the requirements for the training room set by the buyer and that all PC desktops are in working condition and accessing all applicable applications, the training room certified event 808 is completed. For the T-server firewall push event 810, access is allowed to the network to allow CTI information to traffic to and from the T-server. During the IVR programmed event 812, appropriate voice instructions and responses are programmed into the system. For the CTI configuration event 814, genesys (or other appropriate) software installation and configuration occurs, PC names, phone extensions and logins are added to the database and vectors are configured to route call and CTI information to the appropriate locations. The floor certification event 816 occurs when verification of buyer requirements for floor certification are complete and all ACD phones and PC desktops are in working condition and accessing all appropriate applications. The final step, the Go/No-Go decision event 818 occurs after all other steps are satisfactorily completed.

Another phase of call center set-up according to this exemplary embodiment is the implementation-operations phase 108 which ideally runs from week one through week eighteen as shown in FIG. 2, although other time schedules are possible. The flow chart of FIG. 8 shows exemplary events that occur within the implantation-operations phase 108. The first event is review bst release schedules event 902, followed by add partner to retail system event 904, begin T3 training event 906, begin batch 1 training event 908, batch 1 go live event 910, batch 2 go live event 912 and batch 2 nesting complete event 914. The first event, review bst release schedules event 902, covers both a review of timing for new tool deployment and on-going monitoring of any IT issues that might impact the project. During the add partner to retail system event 904, the partner's applicable information is added to the retail system. T3 training consists of training the trainers, team leads and support personnel in a boot camp mode to prepare the vendor's team for the tasks ahead, and this starts in the begin T3 training event 906. Batch 1 training is the first training class for the new call center, delivered by the buyer's trainers with the participation of the seller's trainers and this occurs during the begin batch 1 training event 908. Batch 1 go live event 910 and batch 2 go live event 912 occur when each batch of trainees (agents) start in a slow queue with trainers and other support personnel providing one-on-one support to ensure service will be delivered accordingly to buyers standards. This phase ends with the batch 2 nesting complete event 914 which is when the second batch of trainees (agents) is finished with their time in a slow queue with trainers and other support personnel.

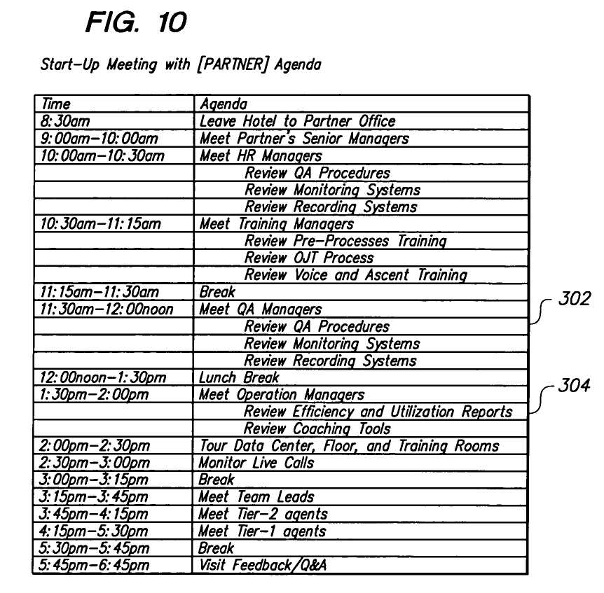

The final phase (to be described) of call center set-up according to this exemplary embodiment is the project management phase 110 which lasts from project start until project completion. The flowchart of FIG. 9 shows some exemplary events that occur as part of the project management phase 110. The first event is kick-off with partner event 202 and the second event is gather lessons learned event 204. In the kick-off with partner event 202, items of interest to both the team setting up the call center and the customer are reviewed in order to streamline setting up the call center. FIG. 10 shows an exemplary embodiment of a meeting agenda with a partner to cover the initial highlights with the appropriate personnel. For example reviewing quality assurance (QA) procedures 302 with the QA managers and reviewing efficiency and utilization reports 304 with the operation managers are items which should be covered early on in the project to ensure success. At the end of the project management phase 110 is the gather lessons learned event 204 to assist in future call center implementations. Lessons learned can be gathered from any step of the overall process where something was improved from the past, where something broke down during the implementation or any other relevant issue. Additional events not illustrated in the flowchart of FIG. 9 may occur during the project management phase 110 such as, reviewing lessons learned from prior call center implementations, review work plans from prior call center implementations, implementing necessary structural items, e.g., establish communication methods, and monitoring project performance. Depending on the function performed during the project management event, the event could be a one time occurrence, or reoccurring as needed during the project management phase.

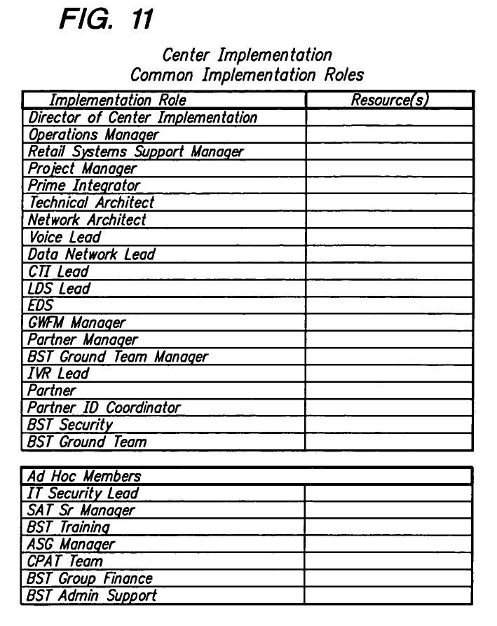

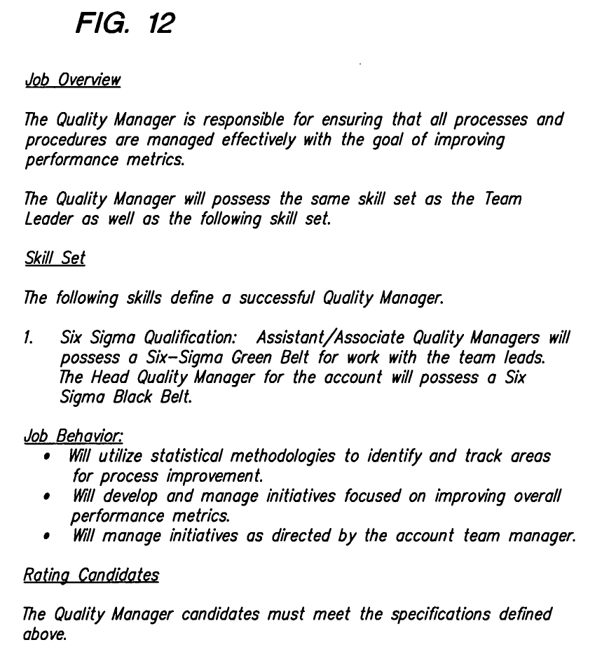

According to exemplary embodiments, a personnel structure exists in order to ensure all of the essential job positions are filled, training needs are met and other standard human resource/personnel functions are completed. An example of key implementation roles is shown in FIG. 11. On the left hand side of the table the implementation role is listed, with the left side being left blank until names can be assigned to each role. This allows for each call center to be set-up by the same functional roles which enhances consistency and efficiency over time. Another important aspect of the personnel structure is to have job descriptions and training packages ready at the correct time and place. An example of an exemplary job description is shown in FIG. 12. An additional example of a function completed by the personnel structure is entering vendor personnel into the system. Additionally when setting up a call center, it could be done by a company for itself, or by a company for or with a partner(s)/customer(s). The exemplary embodiments described above describe a set-up with one company setting up a call center with a customer, but people skilled in the art will understand that many variations are possible.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for setting up a call center comprising the steps of:
determining call types to be handled by said call center and a number of call agents to be supported at said call center;
identifying a list of software applications to be provided to said call center based, at least in part, on said determined call types and number of call agents; and
ordering hardware associated with an automatic call distributor and a plurality of agent terminals to be installed within said call center based, at least in part, on said determined call types and number of call agents.

2. The method of claim 1, wherein said step of determining call types and a number of call agents to be supported is performed during a start-up phase of said method, said start-up phase further including the steps of:
determining call center requirements;
obtaining POP information;
licensing agreements;
shipping collateral; and
performing legal reviews.

3. The method of claim 1, wherein said step of identifying a list of software applications to be provided to said call center is performed during a technical design phase of said method, said technical design phase further including the steps of:
updating an applications list;
creating data strategies;
creating voice strategies; and
reviewing test plans.

4. The method of claim 3, wherein each of said voice strategies is based on said call type.

5. The method of claim 2, wherein said step of ordering hardware is also performed as part of said start-up phase.

6. The method of claim 1, wherein said step of installing said hardware and said software applications is performed during an implementation-technical phase of said method, said implementation-technical phase further comprising the steps of:
configuring routers;
performing firewall pushes;
programming IVR;
configuring and testing the CTI; and
certifying the floor.

7. The method of claim 1, further comprising an implementation-operations phase of said method, said implementation-operations phase further comprising the steps of:
releasing bst schedules;
adding customers to a retail system;
performing training events; and
going live with the call center.

8. The method of claim 1, further comprising a project management phase of said method, said project management phase further comprising the steps of:
kicking off a project;
reviewing lessons learned;
monitoring project performance; and
gathering lessons learned.

9. The method of claim 1, wherein said call center further comprises:
an automatic call distributor; and
a plurality of agent terminals connected to said automatic call distributor via communication links.

10. The method of claim 1, further comprising a personnel structure, said personnel structure further comprising the steps of:
preparing job descriptions; and
preparing training documentation.

11. The method of claim 1, further comprising the step of:
installing said hardware and said software applications to set-up said call center.

12. A computer-readable medium containing instructions which, when executed on a computer, perform the steps of:
determining call types to be handled by said call center and a number of call agents to be supported at said call center;
identifying a list of software applications to be provided to said call center based, at least in part, on said determined call types and number of call agents; and
ordering hardware associated with an automatic call distributor and a plurality of agent terminals to be installed within said call center based, at least in part, on said determined call types and number of call agents.

13. The computer-readable medium of claim 12, wherein said step of identifying a list of software applications to be provided to said call center is performed during a technical design phase, said technical design phase further including the steps of:
updating an applications list;
creating data strategies;
creating voice strategies; and
reviewing test plans.
